(19) United States
(12) Patent Application Publication
(10) Pub. No.: US 2025/0332619 A1
(43) Pub. Date: Oct. 30, 2025

(54) PORTABLE APPARATUS FOR ROLLING AND WASHING A HOSE

(71) Applicant: Robert Carlson, Blacklick, OH (US)

(72) Inventor: Robert Carlson, Blacklick, OH (US)

(21) Appl. No.: 18/645,858

(22) Filed: Apr. 25, 2024

(51) Int. Cl. B08B 3/02; A62C 33/02; B08B 1/12; B08B 1/20; B08B 9/023; B65H 18/08

(52) U.S. Cl. CPC B08B 3/022; B08B 1/12; B08B 1/20; B08B 9/023; B65H 18/08; A62C 33/02; B08B 2203/0247; B08B 2209/02; B65H 2402/42; B65H 2403/941; B65H 2404/62; B65H 2701/33

(57) ABSTRACT

An apparatus for simultaneously rolling up and washing hoses. The apparatus has at least one nozzle and one bristle for washing and scrubbing a hose as it is being rolled onto a hose reel. The apparatus can be connected to a standard garden hose or to a water source on a fire truck. The apparatus washes and scrubs a hose of decontaminates as it is being rolled.

### BACKGROUND OF THE INVENTIVE FIELD

The present invention is directed to an apparatus for rolling a hose and washing a hose at the same time. The hose roller apparatus of the present invention is preferably portable and can be collapsed for easy storage.

Most hoses are walked out and rolled up by hand. There are two main problems with rolling up hoses by hand, especially fire hoses. One, personnel cannot avoid being contaminated by handling the hose. This usually happens when the hose is walked out, disconnected, and rolled up. Secondly, to roll up the hose, one is usually bent over in a position prone for back injury. This present design allows the operator to handle all sections of the hose while standing—simply, disconnect the sections, wash and roll the hose.

When a contaminated hose is rolled up and handled, the firefighters' gloves, gear, and equipment become impregnated with the debris and contaminants caused by fires as well as chemicals used to fight fires. They can't help but spread this debris in the apparatus cab or truck, where it makes its way back to the fire house. Without the present invention, the contaminated hose is typically rolled out and washed at the station, exposing everyone there to its harmful carcinogens and debris. The present invention allows contaminated fire hoses to be rolled and washed simultaneously at the scene of the fire. By washing the hose, gear, and tools on scene, the chances of contamination are reduced.

Most hoses used on a fire scene are drained, rolled up, taken back to the house where it is unrolled, washed, flipped, re-rolled and placed on a rack to dry. A great deal of time is spent in this process. By washing and rolling the hose at the same time at the scene of the fire, the hose can be reloaded immediately at the station without the need to unroll and reroll it.

Prior portable hose rollers are known in the art, but none of the prior rollers are configured to wash or scrub the hose at the same time it is being rolled up onto the reel. The hose roller of the present invention is configured with at least one water nozzle that sprays water onto the hose as it is being rolled up. Preferably, the roller is also configured with a set of bristles that scrub or wash the hose at the same time the hose is being rolled onto the hose reel.

Unlike standard fire hose rollers, the present invention uses water supplied by the fire apparatus/truck, or any standard garden hose water supply, to effectively rinse and scrub away common debris and cancer-causing materials before the hose is reloaded or replaced onto the fire truck or apparatus. By doing so this portable device helps mitigate the spread of carcinogens, while also providing the most ergonomic way to handle hoses before and after all training fires, live fires, hose testing, and hose movement exercises. It's collapsible design aides in its portability, being small enough to fit in most compartments on a variety of vehicles. Along with its scrubbing capability, the hose rolling function eliminates the need of walking out the hose, re-rolling the hose by hand, and multiple other steps in the care of the hose. In other words, the hose can be rolled and washed at the same time at the site of the fire or exercise saving much time and effort (e.g., instead of having to unload/unroll the hoses at the fire station, wash the hoses, and then reroll the hoses for storage). As a bonus, the quick release function provides a flexible spray decontamination wand to provide another source to clean personnel and equipment from debris. This hose roller and washer is the first line in defense for personnel care and safety. By reducing carcinogen exposure and preventing injury it will help firefighters in their battle for longer, healthier careers.

### SUMMARY OF THE GENERAL INVENTIVE CONCEPT

In one embodiment of the invention, the invention is comprised of: a water line for accepting water from a water source; a frame, a hose reel supported by the frame, wherein the hose reel is operationally connected to a crank handle, a slot or opening having an entrance side and an exit side, the slot or opening adapted to accept a hose, and a first nozzle located at the entrance side of the slot or opening, the first nozzle operationally connected to the water line for spraying water onto the hose as it is being rolled up by the apparatus. In the preferred embodiment, the invention is also comprised of a second nozzle located at the entrance side of the slot or opening, the second nozzle operationally connected to the water line for spraying water onto the hose as it is being rolled up by the apparatus, and wherein the first nozzle is located at a position on the apparatus to spray water down on the hose as it is being rolled onto the reel and wherein the second nozzle is located at a position on the apparatus to spray water up on the hose as it is being rolled onto the reel.

In the preferred embodiment, the hose roller and washer of the present invention is also comprised of a shut-off valve located on the water line for opening and closing the water line, a pair of bristles located at the exit side of the slot or opening for cleaning the hose as it is rolled onto the reel, a water diverter operationally connected to the water line for diverting water to the first and second nozzles, a quick release connection attached to the water line configured to allow the water line to be disconnected from the apparatus, a decontamination wand; a retainer located on the frame for releasably holding the decontamination wand onto the frame; and wherein the decontamination wand is adapted to be connected to the quick release connection of the water line and used as a spray wand.

The preferred embodiment of the invention is configured to be connected to a water source on a fire truck or a garden hose.

In the example embodiment, collapsible two-inch stainless steel tubing provides the frame with a bronze bearing installed to accommodate a two-pin winding shaft with handle. The washing head or water diverter is preferably built from stainless steel tubing. It transmits water from the hose connected to its rear to a set of powerful washing nozzles on its front. Two nozzles provide ample cleaning to both sides of the hose. These nozzles wash the hose while a set of bristles in the rear help remove debris and water. As the hose is rolled the hose is cleaned. There are guide plates, pins, and a control valve for water, that aid the operator and function. With quick connect fittings, preferably used at the rear of the water head, the water supply can be detached from the water head with the control valve. The wand can now be attached to the control valve to provide a flexible means of deconning personnel and equipment.

The footprint of the apparatus of the present invention is small, but very effective. The washing head is attached to a collapsible frame. Because of this feature it can become standard equipment on all fire apparatuses, not something left at a station. By receiving its water supply from the fire engine, it takes care of the hose and personnel needs on sight, whether that be on a run, training, or at the fire house grounds.

The foregoing and other features and advantages of the present invention will be apparent from the following more detailed description of the particular embodiments, as illustrated in the accompanying drawings.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates a preferred embodiment of the hose rolling and washing apparatus of the present invention in an uncollapsed state.

FIG. 2 illustrates a preferred embodiment of the hose rolling and washing apparatus of the present invention installed onto the back of a fire truck using a tailboard clamp.

FIG. 3 illustrates a preferred embodiment of the hose rolling and washing apparatus of the present invention in a collapsed state.

FIG. 4 illustrates a preferred embodiment of the hose rolling and washing apparatus of the present invention connected to a water source from a fire truck.

FIG. 5 illustrates a preferred embodiment of the hose rolling and washing apparatus of the present invention with a hose being rolled up.

FIG. 6 illustrates another view of a preferred embodiment of the hose rolling and washing apparatus of the present invention with a hose being rolled up.

FIG. 7 illustrates a front, close-up view of the slot or opening for accepting the hose to be rolled up.

FIG. 8 illustrates a side view of a preferred embodiment of the hose rolling and washing apparatus of the present invention.

FIG. 9 illustrates one example embodiment of the quick release connection.

FIG. 10 illustrates one example embodiment of the spray wand of the present invention.

FIG. 11 illustrates the spray wand of the present invention being used to wash down dirty, contaminated equipment.

FIG. 12 illustrates one embodiment of the hose rolling apparatus of the present invention in the collapsed and locked state.

### DETAILED DESCRIPTION OF EXEMPLARY EMBODIMENT(S)

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

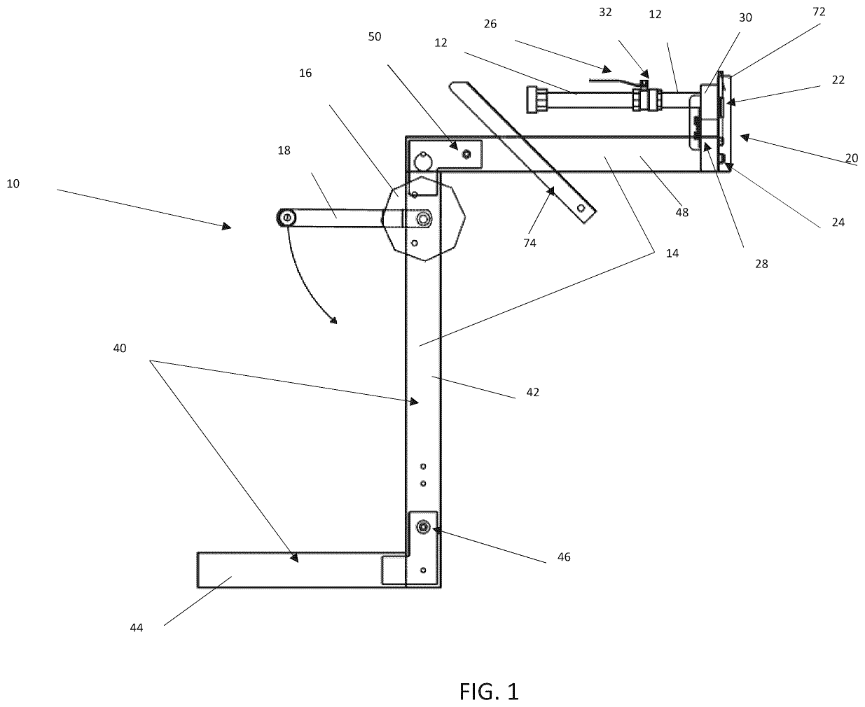

FIG. 1 illustrates a preferred embodiment of the hose rolling and washing apparatus 10 of the present invention in an uncollapsed state. The example embodiment shown is comprised of a water line 12 for accepting water from a water source; a frame 14; a hose reel 16 supported by the frame, wherein the hose reel is operationally connected to a crank handle 18 (operationally connected here means that turning the crank will cause the hose reel to roll up a hose); a slot or opening 20 having an entrance side and an exit side, the slot or opening adapted to accept a hose; and a first nozzle 22 located at the entrance side of the slot or opening. The first nozzle is operationally connected to the water line for spraying water onto the hose as it is being rolled up by the apparatus (e.g., onto the hose reel) (operationally connected here in this context means that water flows from the water line to the nozzle during operation—this connection can be direct or indirect through intervening part(s)). A nozzle is a spout or any other opening, of any shape, for outputting or spraying water. The water line that operationally connects to the water source can be any component that can carry water from one source to another location (e.g., a hose, pipe, tube, etc.). The water line can be flexible or rigid. The crank can be a manual hand crank, or it can be automatic (e.g., motor driven). The crank for the present invention is any component that is used to turn the reel to wind the hose onto the present invention.

In the preferred embodiment, the present invention is comprised of a second nozzle 24 located at the entrance side of the slot or opening. The second nozzle is operationally connected to the water line for spraying water onto the hose as it is being rolled up by the apparatus. The first nozzle is preferably located at a position on the apparatus to spray water down onto the hose as it is being rolled onto the hose reel and the second nozzle is located at a position on the apparatus to spray water up onto the hose as it is being rolled onto the hose reel.

The example embodiment shown is also comprised of a shut-off valve 26 located on the water line for opening and closing the water line; a pair of bristles 28 located at the exit side of the slot or opening for cleaning the hose as it is rolled onto the reel; a water diverter 30 operationally connected to the water line for diverting water to the first and second nozzles. In the example embodiment shown, the water diverter is a C shaped water head or tube for diverting water to the first and second nozzles. A water diverter as used herein is a component that diverts water from one location to one or more other locations (e.g., water lines, hoses pipes, tubes or water heads, etc.).

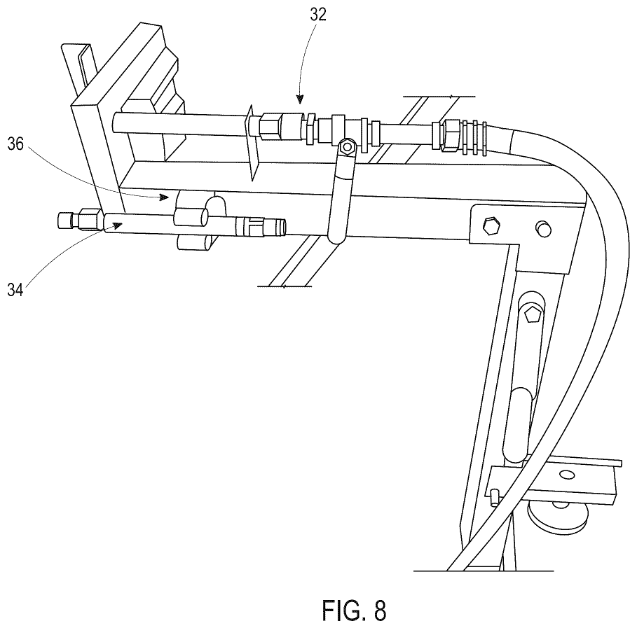

The example embodiment shown is also preferably comprised of a quick release connection 32 attached to the water line adapted to allow the water line to be disconnected from the apparatus. Once the quick release connection is disconnected from the water line, it can be connected to a decontamination wand 34 (shown in FIGS. 8-11) that can than be used to spray down dirty and contaminated equipment. In this example embodiment shown, there is a retainer 36 located on the frame for releasably holding the decontamination wand onto the frame. The decontamination wand is adapted to be connected to the quick release connection of the water line and used as a spray wand for spraying down contaminated equipment.

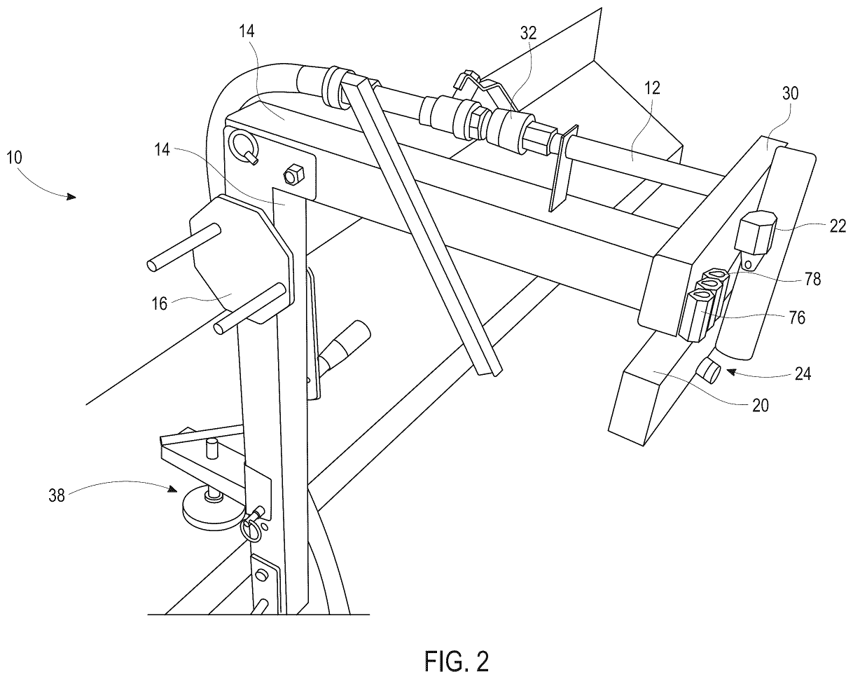

FIG. 2 illustrates a preferred embodiment of the hose rolling and washing apparatus of the present invention installed onto the back of a fire truck using a tailboard clamp 38. In an alternate embodiment, the hose rolling and washing apparatus of the present invention can be connected to a trailer hitch. Being preferably built from stainless steel, the frame and the washing head will offer years of trouble-free service. There are very few moving parts, and its simple, but effective design offers many cost savings benefits. Its design also allows the operator to view the hose for damage at a comfortable upright position.

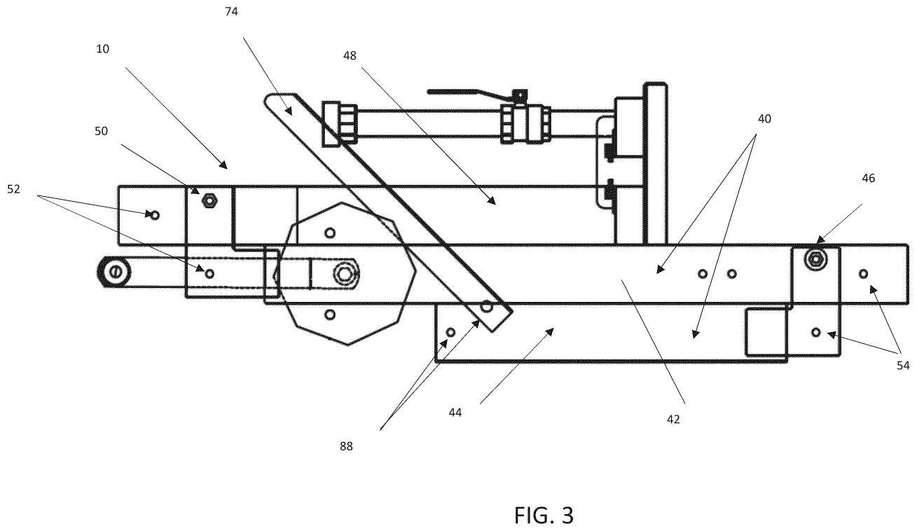

FIG. 3 illustrates a preferred embodiment of the hose rolling and washing apparatus of the present invention in a collapsed state. The frame is further comprised of collapsible stand portion 40 allowing the apparatus to be portable and collapsed for storage. The collapsible stand portion is preferably comprised of a first stand portion 42 and a second stand portion 44 hingeably connected by a first hinge 46. The first stand portion is hingeably connected to the main frame portion 48 by a second hinge 50.

When the unit is collapsed, the first stand portion is sandwiched in between the second stand portion and the main frame portion, and the second (or rear) guide bar 74 lays against one of the sides of the octagon-shaped hose reel plate holding it in place so the reel and handle do not move. The second stand portion is then pinned to the second guide bar by inserting a locking pin 90 into matching holes 88 in the second guide bar and the second stand portion which holds the unit together in the collapsed state (the locking pin is not shown here, see FIG. 12). FIG. 12 illustrates one embodiment of the hose rolling apparatus of the present invention in the collapsed and locked state. In the collapsed state, the device can be easily carried by a person (as shown by the hand holding the unit in FIG. 12). The user can also hold/carry the device by the water line/pipe. As illustrated in FIG. 12, the locking pin 90 is inserted into the matching holes 88 in the second guide bar and the second stand portion. As illustrated, one side of the octagon-shaped hose reel is held in place by a flange 92 on the upper edge of the second guide bar (the flange sticks out in a perpendicular direction from the flat plane of the second guide bar).

As shown in FIG. 1, the first and second stand portions of the frame can be expanded (or uncollapsed) out and pins can be placed in a first pair of matching holes 52 and second pair of matching holes 54 to hold or lock the frame in a uncollapsed/standing state ready to be used. The frame, as broadly used in the present invention, is the portion that provides support for the apparatus and the other components attached/connected to the frame in its operational state. In the preferred embodiment, it provides support for the water line, hose reel and crank and connects to a supporting structure such as a hitch or truck.

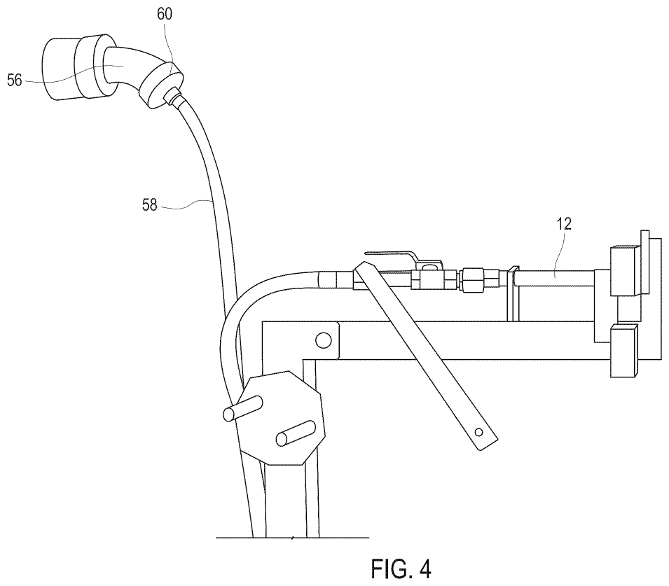

FIG. 4 illustrates a preferred embodiment of the hose rolling and washing apparatus of the present invention connected to a water source 56 from a fire truck. In an alternate embodiment, the water line is configured to be connected to a standard garden hose. In one example embodiment, an adapter hose 58 with an adapter 60 to fit onto the particular water source can be used with the present invention to operationally connect the water source to the hose rolling and washing apparatus of the present invention.

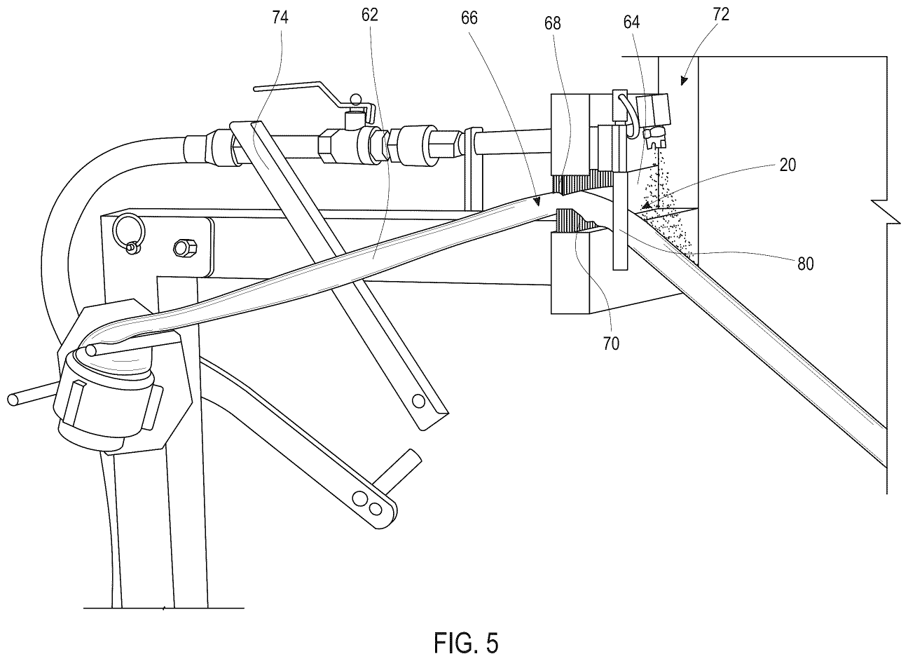

FIG. 5 illustrates a preferred embodiment of the hose rolling and washing apparatus of the present invention with a hose 62 being rolled up. The hose is slid into the slot or opening and the end of the hose is retained by the hose reel. The user than operates the handle (e.g., rotates it) to roll the hose onto the hose reel. As the user cranks the handle, the hose enters an entrance side 64 of the slot and exits via an exit side 66. The first nozzle sprays water onto the top of the hose as it is being reeled in and the second nozzle sprays water onto the bottom of the hose as it is being reeled in. A pair of bristles 28 located at the exit side of the slot or opening scrubs or cleans the hose as it is rolled onto the reel. In other words, an upper bristle 68 scrubs the top of the hose as it is being reeled in and a lower bristle 70 scrubs the bottom of the hose as it is being reeled in. In this example embodiment, the bristles are mounted on the C-shaped water diverter.

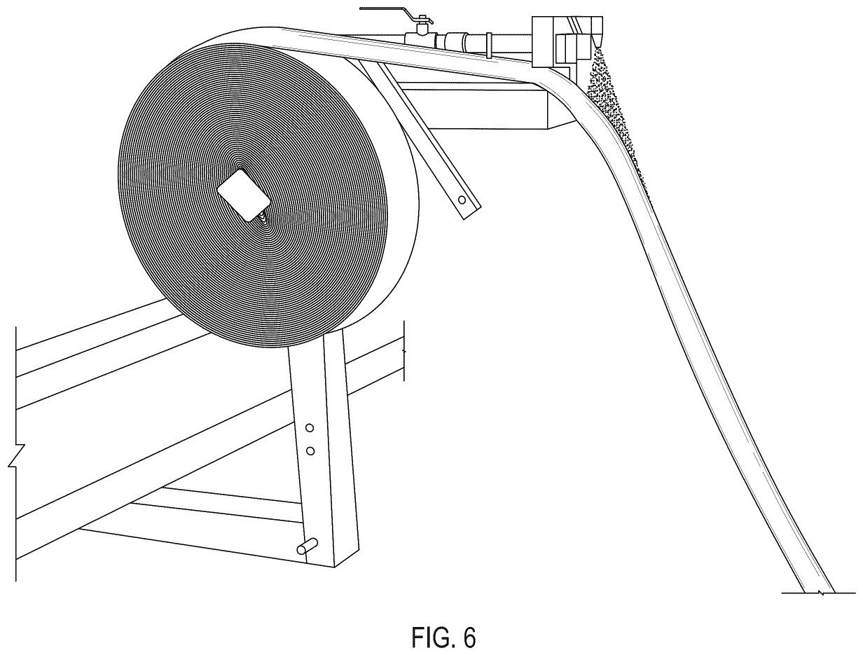

As the hose is being reeled in, a first (or front) guide bar 72 located at entrance side of the slot assists in guiding the hose into the slot. A second (or rear) guide bar 74, supported by the frame in a diagonal orientation with respect to the plane that the hose is reeled into the slot, guides the hose as it is being rolled onto the hose reel. The second guide bar is preferably of sufficient length to guide the hose as it is being reeled onto the reel. FIG. 6 illustrates another view of a preferred embodiment of the hose rolling and washing apparatus of the present invention with a hose being rolled up.

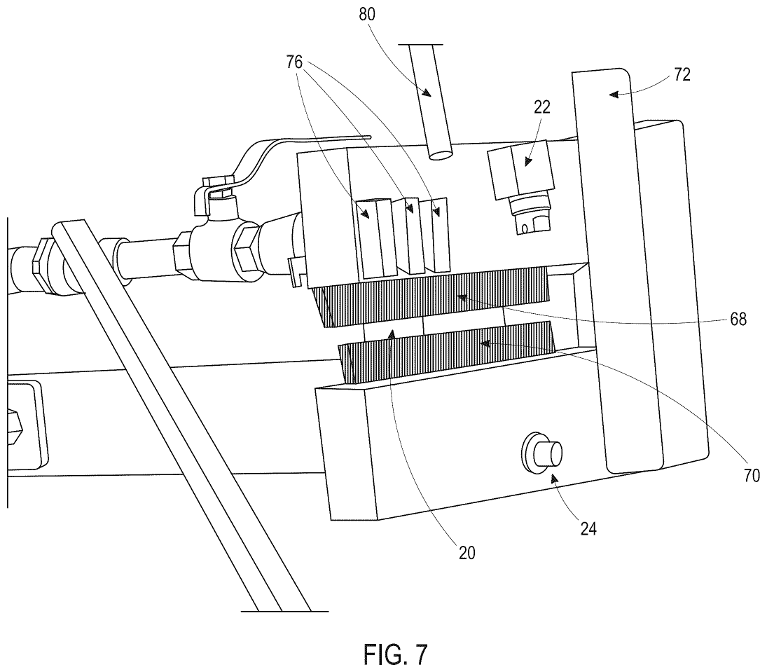

FIG. 7 illustrates a front, close-up view of the slot or opening for accepting the hose to be rolled up. As shown, the hose rolling apparatus is configured with a plurality of vertically oriented slots 76 with openings 78 (shown better in FIG. 2) for accepting a retaining pin 80 (the embodiment shown has three vertically oriented slots). The pin is placed into a particular vertically oriented slot based on the size of the hose. The retaining pin holds the hose in the slot and prevents it from moving out of the slot as the hose is being reeled in (in FIG. 7, the retaining pin is shown hovering over the vertically oriented slots but has not been placed in any of the openings, FIG. 5 shows the pin inserted into one of the vertically oriented slots to retain the hose in the slot 20 as it is being reeled in).

FIG. 8 illustrates a side view of a preferred embodiment of the hose rolling and washing apparatus of the present invention. Once the quick release connection is disconnected from the water line, it can be connected to a decontamination wand 34 (shown in FIGS. 8-11) that can then be used to spray down dirty and contaminated equipment. In this example embodiment shown, there is a retainer 36 located on the frame for releasably holding the decontamination wand onto the frame. The decontamination wand is adapted to be connected to the quick release connection of the water line and used as a spray wand for spraying down contaminated equipment.

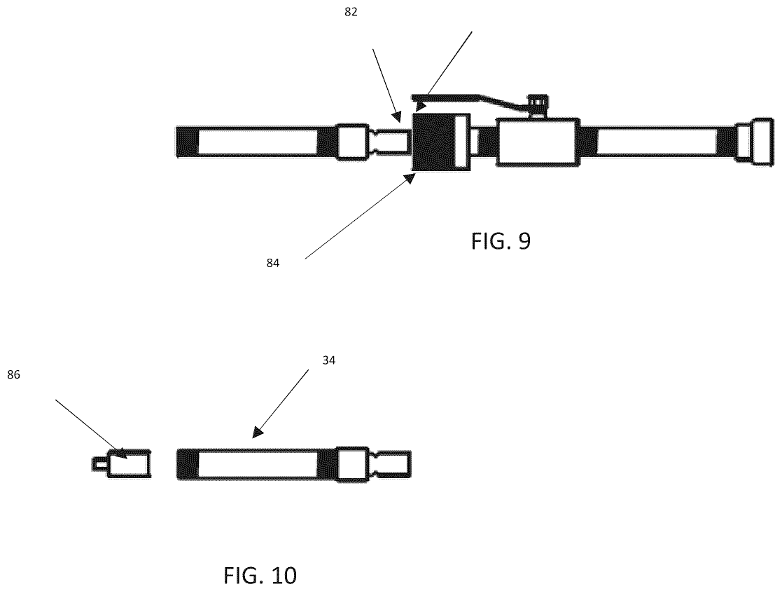

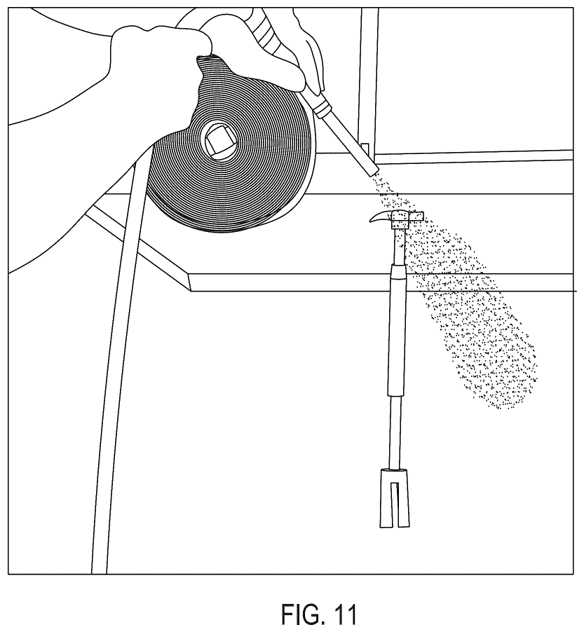

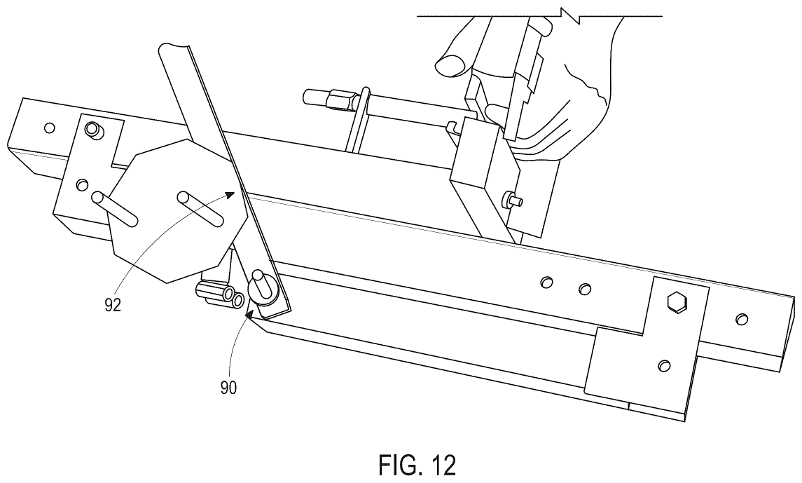

FIG. 9 illustrates one example embodiment of the quick release connection. The quick release connection is preferably comprised of male 82 portion and a female portion 84. FIG. 10 illustrates one example embodiment of the decontamination wand of the present invention. Once disconnected, the quick release connection can be connected to the decontamination “spray” wand that has a nozzle portion 86. FIG. 11 illustrates the spray wand of the present invention being used to wash down dirty, contaminated equipment.

Although the aforementioned describes embodiments of the invention, the invention is not so restricted. It will be apparent to those skilled in the art that various modifications and variations can be made to the disclosed embodiments of the present invention without departing from the scope or spirit of the invention. Accordingly, these other hose rollers, water lines, water diverters, and frames, etc. are fully within the scope of the claimed invention. Therefore, it should be understood that the apparatuses and methods described herein are illustrative only and are not limiting upon the scope of the invention, which is indicated by the following claims.

What is claimed is:

1. An apparatus for rolling up a hose and washing it at the same time, the apparatus comprising:
a water line for accepting water from a water source;
a frame;
a hose reel supported by the frame, wherein the hose reel is operationally connected to a crank;
a first nozzle, wherein the first nozzle is operationally connected to the water line, and wherein the first nozzle is positioned on the apparatus to spray water onto the hose as it is being rolled onto the hose reel.

2. The apparatus according to claim 1, further comprising:
a slot or opening having an entrance side and an exit side, the slot or opening adapted to accept the hose;
a second nozzle, wherein the second nozzle is operationally connected to the water line, and wherein the second nozzle is positioned on the apparatus to spray water onto the hose as it is being rolled onto the hose reel;
wherein the first nozzle is positioned on the apparatus to spray water down onto the hose as it is being rolled onto the hose reel and wherein the second nozzle is positioned on the apparatus to spray water up onto the hose as it is being rolled onto the hose reel; and
wherein the first and second nozzles are located at the entrance side of the slot or opening.

3. The apparatus according to claim 1, further comprising:
a shut-off valve located on the water line for opening and closing the water line.

4. The apparatus according to claim 1, further comprising:
a pair of bristles positioned on the apparatus for scrubbing the hose as it is rolled onto the hose reel.

5. The apparatus according to claim 2, further comprising:
a water diverter operationally connected to the water line for diverting water to the first and second nozzles.

6. The apparatus according to claim 5, wherein the diverter is a C shaped water head or tube for diverting water to the first and second nozzles.

7. The apparatus according to claim 1, further comprising:
a quick release connection attached to the water line adapted to allow the water line to be disconnected from the apparatus.

8. The apparatus according to claim 7, further comprising:
a decontamination wand;
a retainer located on the frame for releasably holding the decontamination wand on the frame; and
wherein the decontamination wand is adapted to be connected to the quick release connection of the water line and used as a spray wand.

9. The apparatus according to claim 1, further comprising:
a vehicle tailboard clamp attached to the frame for releasably connecting the apparatus to a vehicle tailboard.

10. The apparatus according to claim 1, wherein the frame is further comprised of collapsible stand portion allowing the apparatus to be portable and collapsed for storage.

11. The apparatus according to claim 1, wherein the water line is adapted to be connected to a water source on a fire truck or a garden hose.

12. The apparatus according to claim 2, further comprising:
a pin; and
a plurality of vertically oriented slots with openings for accepting the pin, and wherein the plurality of vertically oriented slots are arranged on the apparatus to retain hoses of different sizes in the slot as it is being rolled onto the hose reel.

13. The apparatus according to claim 2, further comprising:
a first or front guide bar located at a first side of the slot for assisting in guiding the hose into the slot;
a second or rear guide bar supported by the frame in a diagonal orientation with respect to the plane that the hose is reeled into the slot, and wherein the second or rear guide bar is of sufficient length to guide the hose as it is being reeled onto the hose reel.

14. An apparatus for rolling up a hose and washing it at the same time, the apparatus comprising:
a water line for accepting water from a water source;
a frame;
a hose reel supported by the frame, wherein the hose reel is operationally connected to a crank;
a first nozzle, the first nozzle is operationally connected to the water line and wherein the first nozzle is positioned on the apparatus to spray water onto the hose as it is being rolled onto the hose reel; and
a pair of bristles positioned on the apparatus for scrubbing the hose as it is rolled onto the hose reel.

15. The apparatus according to claim 14, further comprising:
a slot or opening having an entrance side and an exit side, the slot or opening adapted to accept the hose;
a second nozzle, wherein the second nozzle is operationally connected to the water line, and wherein the second nozzle is positioned on the apparatus to spray water onto the hose as it is being rolled onto the hose reel;
wherein the first nozzle is positioned on the apparatus to spray water down onto the hose as it is being rolled onto the hose reel and wherein the second nozzle is positioned on the apparatus to spray water up onto the hose as it is being rolled onto the hose reel;
wherein the first and second nozzles are located at the entrance side of the slot or opening; and
wherein the crank is a manual hand crank.

16. The apparatus according to claim 14, further comprising:
a quick release connection attached to the water line adapted to allow the water line to be disconnected from the apparatus.

17. The apparatus according to claim 16, further comprising:
a decontamination wand;
a retainer located on the frame for releasably holding the decontamination wand on the frame; and
wherein the decontamination wand is adapted to be connected to the quick release connection of the water line and used as a spray wand.

18. An apparatus for rolling up a hose and washing it at the same time, the apparatus comprising:
a water line for accepting water from a water source;
a frame;
a hose reel supported by the frame, wherein the hose reel is operationally connected to a crank handle;
a slot or opening having an entrance side and an exit side, the slot or opening adapted to accept the hose;
a first nozzle located at the entrance side of the slot or opening, wherein the first nozzle is operationally connected to the water line, and wherein the first nozzle is positioned on the apparatus to spray water onto the hose as it is being rolled onto the hose reel;
a quick release connection attached to the water line adapted to allow the water line to be disconnected from the apparatus;
a decontamination wand;
a retainer located on the frame for releasably holding the decontamination wand on the frame; and
wherein the decontamination wand is adapted to be connected to the quick release connection of the water line and used as a spray wand.

19. The apparatus according to claim 18, further comprising:
a second nozzle located at the entrance side of the slot or opening, wherein the second nozzle is operationally connected to the water line and wherein the second nozzle is positioned on the apparatus to spray water onto the hose as it is being rolled onto the hose reel;
wherein the first nozzle is positioned on the apparatus to spray water down onto the hose as it is being rolled onto the hose reel and wherein the second nozzle is positioned on the apparatus to spray water up onto the hose as it is being rolled onto the hose reel.

20. The apparatus according to claim 18, further comprising:
a pair of bristles located at the exit side of the slot or opening for scrubbing the hose as it is rolled onto the hose reel.

21. The apparatus according to claim 1, further comprising:
a rear guide bar having a flanged edge;
wherein the frame is further comprised of a main frame portion, a first stand portion, and a second stand portion, and wherein the first stand portion is hingeably connected to the second stand portion, and the first stand portion is hingeably connected to the main frame portion, and wherein the first stand portion is sandwiched in between the second stand portion and the main frame portion when the apparatus is in a collapsed state;
wherein the hose reel is in a predetermined shape and wherein a side of the predetermined shaped hose reel rests against the flanged edge of the rear guide bar when in the collapsed state so that the hose reel does not move when in a locked state.

22. The apparatus according to claim 18, further comprising:
a rear guide bar having a flanged edge;
wherein the frame is further comprised of a main frame portion, a first stand portion, and a second stand portion, and wherein the first stand portion is hingeably connected to the second stand portion, and the first stand portion is hingeably connected to the main frame portion, and wherein the first stand portion is sandwiched in between the second stand portion and the main frame portion when the apparatus is in a collapsed state;
wherein the hose reel is in an octagonal shape and wherein a side of the octagon-shaped hose reel rests against the flanged edge of the rear guide bar when in the collapsed state so that the hose reel does not move when in a locked state.
